(19) United States
(12) Patent Application Publication
(10) Pub. No.: US 2026/0296978 A1
(43) Pub. Date: Oct. 1, 2026

(54) DIELECTRIC COMPOSITION, DIELECTRIC ELEMENT, ELECTRONIC DEVICE, AND MULTILAYER ELECTRONIC DEVICE

(71) Applicant: TDK Corporation, Tokyo (JP)

(72) Inventor: Ryota NOMURA, Tokyo (JP)

(73) Assignee: TDK Corporation, Tokyo (JP)

(21) Appl. No.: 19/576,407

(22) Filed: Mar. 24, 2026

(30) Foreign Application Priority Data
Mar. 27, 2025 (JP) 2025-054105

(51) Int. Cl. C04B 35/48; C04B 35/47

(52) U.S. Cl. CPC C04B 35/48; C04B 35/47; C04B 2235/3236; C04B 2235/3248; C04B 2235/768

(57) ABSTRACT

A dielectric composition includes a dielectric grain. The dielectric grain includes a core portion and a shell portion. The core portion contains a first perovskite oxide as a main component. The shell portion contains the first perovskite oxide and a second perovskite oxide as a main component. The second perovskite oxide has a composition different from that of the first perovskite oxide. The first perovskite oxide contains at least one selected from the group consisting of Ba, Sr, and Ca at the A-site and at least one selected from the group consisting of Ti and Zr at the B-site. The second perovskite oxide contains at least one selected from the group consisting of Ba, Sr, and Ca at the A-site and at least one selected from the group consisting of Ti and Zr at the B-site.

### TECHNICAL FIELD

The present disclosure relates to a dielectric composition, a dielectric element, an electronic device, and a multilayer electronic device.

### BACKGROUND

Patent Document 1 discloses an invention related to an LTCC ceramic composition. With a main component including CaZrO₃ and CaTiO₃ and Li₂O—B₂O₃—SiO₂—CaO-Al₂O₃ based glass frit, the ceramic composition can have its temperature characteristics suitably controlled.

Patent Document 2 discloses an invention related to a dielectric ceramic. Simultaneously firing a compact containing a perovskite compound and Li and a composition containing Li can provide a dielectric ceramic with high moisture resistance.

Patent Document 3 discloses an invention related to a dielectric ceramic composition. With barium titanate as a main component and further a component containing barium zirconate and strontium zirconate, a Mg oxide, a Gd oxide, a Mn oxide, and a compound containing Si all within specific ranges, the dielectric ceramic composition suitably used at medium and high voltages can be provided.
Patent Document 1: JP Patent No. 4473099
Patent Document 2: JP Patent No. 5040971
Patent Document 3: JP Patent No. 5488118

### SUMMARY

A dielectric composition of the present disclosure is
a dielectric composition including a dielectric grain, wherein
the dielectric grain includes a core portion and a shell portion;
the core portion contains a first perovskite oxide as a main component;
the shell portion contains the first perovskite oxide and a second perovskite oxide as a main component, the second perovskite oxide having a composition different from that of the first perovskite oxide;
the first perovskite oxide contains at least one selected from the group consisting of Ba, Sr, and Ca at the A-site and at least one selected from the group consisting of Ti and Zr at the B-site; and
the second perovskite oxide contains at least one selected from the group consisting of Ba, Sr, and Ca at the A-site and at least one selected from the group consisting of Ti and Zr at the B-site.

### BRIEF DESCRIPTION OF THE DRAWING(S)

FIG. 1 is a schematic sectional view of a multilayer electronic device according to one embodiment of the present disclosure.

FIG. 2 is a schematic sectional view of a dielectric layer 2.

FIG. 3 is a partial enlarged schematic view of FIG. 2.

FIG. 4 is a graph of example results of a line analysis.

FIG. 5 is a graph of partial details of FIG. 4.

### DETAILED DESCRIPTION

It is an object of the present disclosure to provide a dielectric composition or the like that has low dielectric loss at high frequency bandwidth, has high insulation resistance, and is capable of being simultaneously fired with a conductor containing Cu.

It may be that, in the dielectric composition according to the present disclosure,
the first perovskite oxide contains Ca most at the A-site and Zr most at the B-site based on number of atoms, and
the second perovskite oxide contains Sr most at the A-site and Ti most at the B-site based on number of atoms.

It may be that, in the dielectric composition according to the present disclosure,
the first perovskite oxide contains 50.0 at % or more Ca at the A-site and 50.0 at % or more Zr at the B-site, and
the second perovskite oxide contains 50.0 at % or more Sr at the A-site and 50.0 at % or more Ti at the B-site.

It may be that, in the dielectric composition according to the present disclosure,
the first perovskite oxide contains 60.0 at % or more Ca at the A-site and 60.0 at % or more Zr at the B-site, and
the second perovskite oxide contains 60.0 at % or more Sr at the A-site and 60.0 at % or more Ti at the B-site.

It may be that, in the dielectric composition according to the present disclosure,
the first perovskite oxide contains 70.0 at % or more Ca at the A-site and 70.0 at % or more Zr at the B-site, and
the second perovskite oxide contains 70.0 at % or more Sr at the A-site and 70.0 at % or more Ti at the B-site.

It may be that, in the dielectric composition according to the present disclosure,
the first perovskite oxide contains CaZrO₃, and
the second perovskite oxide contains SrTiO₃.

It may be that, in the dielectric composition according to the present disclosure,
a content ratio of the second perovskite oxide to a total of the first perovskite oxide and the second perovskite oxide in the shell portion is 0.010 or more and 0.10 or less based on number of atoms.

It may be that, in the dielectric composition according to the present disclosure,
a content ratio of the second perovskite oxide to a total of the first perovskite oxide and the second perovskite oxide in the shell portion is 0.025 or more and 0.070 or less based on number of atoms.

It may be that, in the dielectric composition according to the present disclosure,
based on number of atoms, the core portion has a smaller content ratio of the second perovskite oxide to a total of the first perovskite oxide and the second perovskite oxide than the shell portion.

It may be that, in the dielectric composition according to the present disclosure,
the content ratio of the second perovskite oxide to the total of the first perovskite oxide and the second perovskite oxide in the core portion is 0.

It may be that, in the dielectric composition according to the present disclosure,
the dielectric grain includes dielectric grains,
the dielectric composition includes a grain boundary between the dielectric grains, and
the grain boundary contains an oxide of at least one selected from the group consisting of Si, Mn, Sr, and Ti.

It may be that, in the dielectric composition according to the present disclosure,
the dielectric grain includes dielectric grains,
the dielectric composition includes a grain boundary between the dielectric grains, and
the grain boundary contains all of a Si oxide, a Mn oxide, a Sr oxide, and a Ti oxide.

It may be that, in the dielectric composition according to the present disclosure, the shell portion contains Mn.

It may be that, in the dielectric composition according to the present disclosure, the shell portion has an average Mn content of 0.5 mol % or more.

A dielectric element according to the present disclosure contains the above dielectric composition.

An electronic device according to the present disclosure contains the above dielectric composition.

A multilayer electronic device according to the present disclosure includes
dielectric layers containing the above dielectric composition, and
internal electrode layers,
wherein the dielectric layers and the internal electrode layers are alternately laminated.

It may be that, in the multilayer electronic device according to the present disclosure, the internal electrode layers contain Cu.

An embodiment of the present disclosure is described below with reference to the drawings. In the drawings, common members are given the same reference numerals, and their description is partly omitted. The present disclosure is not construed as limited to the following embodiment and can be put into practice with appropriate changes within the scope of the object of the present disclosure. Redundant description may be appropriately omitted; however, this is not construed as limiting the gist of the invention.

Hereinafter, one embodiment of the present disclosure is described using an example of a multilayer electronic device and a method of manufacturing the same.

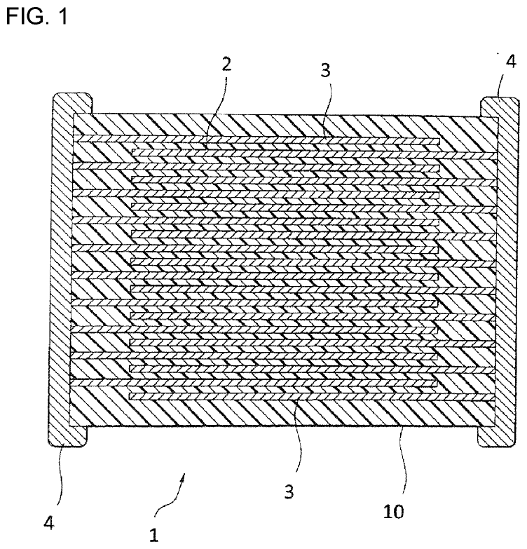

As illustrated in FIG. 1, a multilayer ceramic capacitor 1, which is a multilayer electronic device, according to the present embodiment includes a capacitor element body 10 including dielectric layers 2 and internal electrode layers 3 being alternately laminated. At both ends of the capacitor element body 10, external electrodes 4 in pairs are provided. The external electrodes 4 are electrically connected to the internal electrode layers 3 alternately arranged in the capacitor element body 10. The capacitor element body 10 may have any shape but normally has a rectangular parallelepiped shape. The capacitor element body 10 may have any dimensions, which are appropriately determined according to a use. Where the dielectric layers 2 and the internal electrode layers 3 are alternately laminated is referred to as a laminated portion.

The internal electrode layers 3 are laminated so that their ends are alternately exposed to surfaces of two end surfaces of the capacitor element body 10 facing each other. The external electrodes 4 in pairs are provided at both end surfaces of the capacitor element body 10 and are connected to the exposed ends of the alternately arranged internal electrode layers 3 to form a capacitor circuit.

The dielectric layers 2 may have any thickness. They may each have a thickness of 50 μm or less or 30 μm or less. The lower limit of the thickness is not limited and is, for example, about 0.5 μm.

The number of the dielectric layers 2 is not limited. The number may be 20 or more or may be 50 or more.

The internal electrode layers 3 may contain any conductive material. The internal electrode layers 3 may contain at least one selected from the group consisting of Cu, Ag, Au, Ni, and Pd or may contain Cu. The proportion of the at least one selected from the group consisting of Cu, Ag, Au, Ni, and Pd is not limited. The proportion may be, for example, 20 at % or more in total. The internal electrode layers 3 may contain 50 at % or more Cu. It may be that the internal electrode layers 3 substantially contain only Cu, i.e., the internal electrode layers 3 may contain 99 at % or more Cu.

The internal electrode layers 3 of the multilayer electronic device according to the present embodiment may have a relatively low melting point. Specifically, the melting point may be 1100° C. or less.

To form the internal electrode layers 3, a commercially available electrode paste may be used. The thickness of the internal electrode layers 3 is appropriately determined according to a use or the like. The internal electrode layers 3 may each have a thickness of, for example, 0.2 μm or more and 20.0 μm or less.

The external electrodes 4 may contain any conductive material. In the present embodiment, for example, inexpensive Ni or Cu; highly heat-resistant Au, Ag, or Pd; or an alloy of Ni, Cu, Au, Ag, and/or Pd can be used. The external electrodes 4 have a thickness appropriately determined according to a use or the like. Normally, the thickness may be about 10 to 50 μm.

Detailed description of a dielectric composition constituting the dielectric layers 2 according to the present embodiment is provided next.

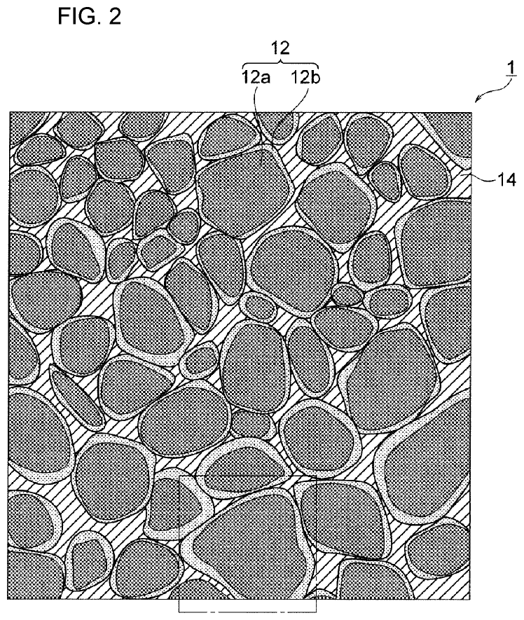

FIG. 2 is a schematic sectional view of the dielectric composition according to the present embodiment. As illustrated in FIG. 2, the dielectric composition includes dielectric grains 12 and a grain boundary 14 between the dielectric grains 12.

The dielectric grains contain perovskite oxides. The dielectric grains 12 each include a core portion 12a at a central portion and a shell portion 12b at a peripheral portion.

A perovskite oxide is an oxide that is represented by a formula ABO₃ and has a perovskite crystal structure. “A” of the formula includes at least one element of the A-site. “B” of the formula includes at least one element of the B-site.

The dielectric grains 12 contain at least two perovskite oxides. The core portion 12a contains a first perovskite oxide. The shell portion 12b contains the first perovskite oxide and a second perovskite oxide having a composition different from that of the first perovskite oxide.

For example, at least either the elements at the A-sites of the first perovskite oxide and the second perovskite oxide or the elements at the B-sites of the first perovskite oxide and the second perovskite oxide may differ by 1.0 at % or more or may differ by 30 at % or more.

The first perovskite oxide contains at least one selected from the group consisting of Ba, Sr, and Ca at the A-site and at least one selected from the group consisting of Ti and Zr at the B-site.

It may be that the first perovskite oxide contains Ca most at the A-site and Zr most at the B-site based on the number of atoms and that the second perovskite oxide contains Sr most at the A-site and Ti most at the B-site based on the number of atoms.

It may be that the first perovskite oxide contains 50.0 at % or more Ca at the A-site and 50.0 at % or more Zr at the B-site and that the second perovskite oxide contains 50.0 at % or more Sr at the A-site and 50.0 at % or more Ti at the B-site.

It may be that the first perovskite oxide contains 60.0 at % or more Ca at the A-site and 60.0 at % or more Zr at the B-site and that the second perovskite oxide contains 60.0 at % or more Sr at the A-site and 60.0 at % or more Ti at the B-site.

It may be that the first perovskite oxide contains 70.0 at % or more Ca at the A-site and 70.0 at % or more Zr at the B-site and that the second perovskite oxide contains 70.0 at % or more Sr at the A-site and 70.0 at % or more Ti at the B-site.

It may be that the first perovskite oxide contains CaZrO₃ and that the second perovskite oxide contains SrTiO₃.

The core-shell structure of the dielectric grains 12 containing the at least two perovskite oxides as described above facilitates liquid phase sintering particularly in the shell portion 12b during firing. Consequently, the dielectric grains 12 can have sufficiently high sinterability even at a low temperature (e.g., about 1000° C. or less).

The dielectric grains 12 may have any circle equivalent diameters in a section of the dielectric composition. The circle equivalent diameters may be, for example, 0.01 μm or more and 10 μm or less. Note that the circle equivalent diameter of a dielectric grain means the diameter of a circle having the same area as that of the dielectric grain. Also note that the shell portion 12b refers to a portion at a distance of 30% or less of the circle equivalent diameter of the dielectric grain 12 from its outer periphery and that the core portion 12a refers to a portion other than the shell portion 12b of the dielectric grain 12.

The content ratio of the second perovskite oxide to the total of the first perovskite oxide and the second perovskite oxide in the shell portion 12b may be, based on the number of atoms, 0.001 or more and 0.15 or less, 0.005 or more and 0.13 or less, 0.010 or more and 0.10 or less, 0.020 or more and 0.075 or less, or 0.025 or more and 0.070 or less. Hereinafter, the “content ratio of the second perovskite oxide to the total of the first perovskite oxide and the second perovskite oxide in the shell portion 12b” may be referred to as “α”. In particular, an a of 0.025 or more and 0.070 or less easily reduces dielectric loss.

The content ratio of the second perovskite oxide to the total of the first perovskite oxide and the second perovskite oxide in the core portion 12a is smaller than α. The content ratio of the second perovskite oxide to the total of the first perovskite oxide and the second perovskite oxide in the core portion 12a may be α×0.1 or less, α×0.01 or less, or 0.

The grain boundary 14 may have any composition. The grain boundary 14 may contain an oxide of at least one selected from the group consisting of Si, Mn, Sr, Ti, Li, B, Na, Al, P, Zn, Y, Ag, Ba, Ca, and Zr; an oxide of at least one selected from the group consisting of Si, Mn, Sr, and Ti; or a Mn oxide. The grain boundary 14 may contain all of a Si oxide, a Mn oxide, a Sr oxide, and a Ti oxide. The oxide of each element may be a simple oxide of the element or may be a complex oxide containing the element. The grain boundary 14 may have any microstructure. The grain boundary 14 may have a crystal structure or may have an amorphous structure. The grain boundary 14 may have a pore.

In addition to the grain boundary 14, the shell portion 12b may at least partly contain Mn. Specifically, the shell portion 12b may include a portion having a Mn content of 0.5 mol % or more based on the number of atoms. The shell portion 12b may have an average Mn content of 0.5 mol % or more. In a situation where the shell portion 12b at least partly contains Mn, insulation resistance in particular is easily improved. In a situation where 0.020≤α≤0.055 is satisfied in particular, it is easy for the shell portion 12b to at least partly contain Mn.

With reference to the drawings, the following description is provided on the premise that the first perovskite oxide is CaZrO₃, the second perovskite oxide is SrTiO₃, and the grain boundary 14 contains Si, Mn, Sr, and Ti.

Methods of checking the microstructure of the dielectric composition are not limited. Such methods include those involving an apparatus using SEM-EDS or STEM-EDS.

A field of view is determined in a section of the dielectric composition. A HAADF image of the field of view is observed using the above apparatus. Moreover, elemental mapping images are created. The elemental mapping images may be images of elements relatively highly contained in the dielectric composition. The images of, for example, Ca, Zr, Sr, Ti, Si, and Mn may be created. Some of the elemental mapping images may be superimposed on the other. If the field of view includes a portion other than the dielectric composition (e.g., electrode portion), such a portion other than the dielectric composition is ignored in the following observation or analysis unless otherwise specified.

As illustrated in FIG. 2, it can be confirmed, from the HAADF image, that the dielectric composition includes the dielectric grains 12 and the grain boundary 14. Using observation together with the elemental mapping images of the dielectric grains 12, it can be confirmed that the dielectric grains 12 include both the core portion 12a, which contains the first perovskite oxide, and the shell portion 12b, which contains the first perovskite oxide and the second perovskite oxide.

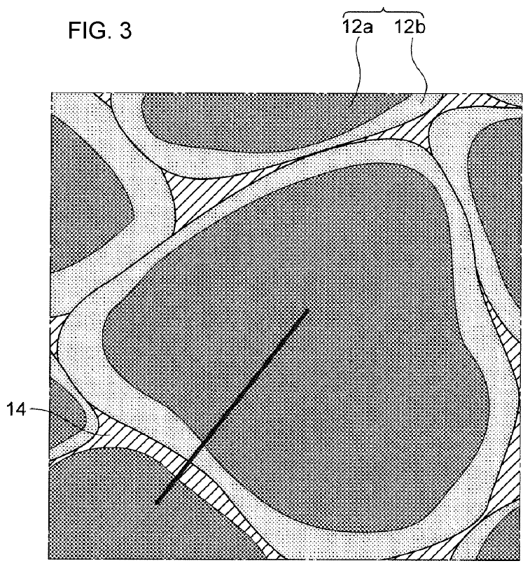

A boxed portion of FIG. 2 is enlarged in FIG. 3. The boxed portion exceeds the field of view illustrated in FIG. 2. This exceeded portion is also included in FIG. 3. A line analysis may be performed to measure the content ratio of the second perovskite oxide to the total of the first perovskite oxide and the second perovskite oxide in the shell portion 12b.

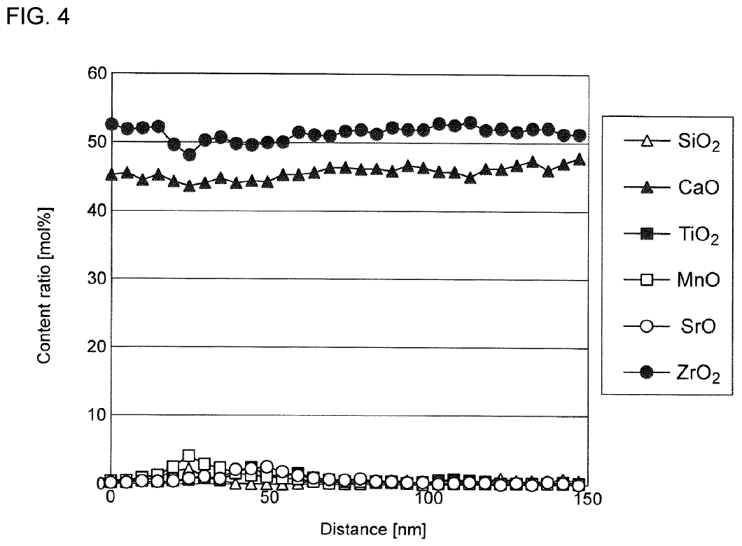

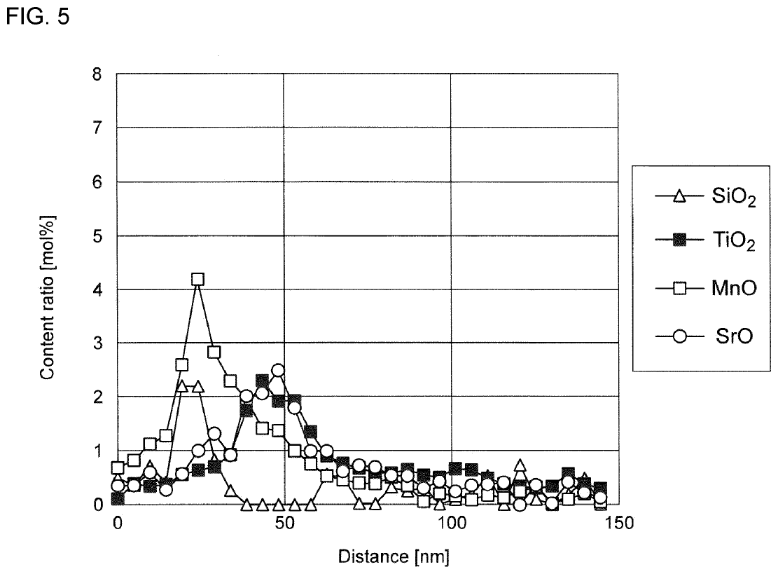

FIGS. 4 and 5 are graphs showing results of the line analysis performed from the bottom up along a line illustrated in FIG. 3. What is analyzed in the line analysis is each element content. FIGS. 4 and 5 show the content of each element in terms of its simple oxide.

As illustrated in FIG. 4, the content of Ca and the content of Zr, which constitute the first perovskite oxide, are high overall. According to FIGS. 3 and 4, it can be confirmed that the first perovskite oxide is contained in the core portion 12a and the shell portion 12b. The grain boundary 14 also has a high Ca content and a high Zr content; however, it is assumed that Ca and Zr are contained in the grain boundary 14 mostly not as a perovskite oxide but as a Ca oxide and a Zr oxide. It is also assumed that characteristic X-rays of the elements of the surrounding dielectric grains 12, particularly their shell portions 12b, may be caught.

FIG. 5 is a graph enlargedly showing a portion of FIG. 4 where the content is 8 mol % or less. According to FIGS. 3 and 5, it can be confirmed that the peripheral portion of the dielectric grain 12 contains Sr and Ti. That is, it can be confirmed that the second perovskite oxide in addition to the first perovskite oxide is contained in the shell portion 12b of the dielectric grain 12. It can also be confirmed that the second perovskite oxide is contained more in the shell portion 12b of the dielectric grain than in the core portion 12a of the dielectric grain. As for calculation of a, the content ratio of SrTiO₃ to the total of CaZrO₃ and SrTiO₃ at each measurement point included in the shell portion 12b can be calculated and averaged.

As illustrated in FIGS. 3 and 5, a portion corresponding to the grain boundary 14 has a high content of elements not contained in the first perovskite oxide or the second perovskite oxide, such as, in particular, Si and Mn. Si is almost not contained in portions other than the grain boundary 14. Mn is contained more in the shell portion 12b than in the grain boundary 14.

Whether an element or a compound is contained in a portion may be determined using a threshold of 0.5 mol %. In other words, an element or a compound whose content is less than 0.5 mol % may be deemed to be not contained.

That the core portion and the shell portion of the dielectric grain 12 contain Ca and Zr not as their respective simple oxides but as a perovskite oxide and that particularly the shell portion 12b contains Sr and Ti not as their respective simple oxides but as a perovskite oxide can be confirmed using electron diffraction patterns.

An example method of manufacturing the multilayer ceramic capacitor is described next. The following description is provided on the premise that the first perovskite oxide is CaZrO₃, the second perovskite oxide is SrTiO₃, and the grain boundary contains Si, Mn, Sr, and Ti.

Similarly to a conventional multilayer ceramic capacitor, the multilayer ceramic capacitor 1 of the present embodiment is manufactured by preparing a green chip with a normal printing or sheet method using pastes, firing the green chip, and applying external electrodes onto the fired chip and baking them.

As raw material powders of the above dielectric layers 2, a Ca oxide raw material powder and a Zr oxide raw material powder are prepared. A raw material powder of an oxide of an element means a powder of the oxide of the element and/or a powder of a compound that becomes the oxide of the element through a heat treatment. The powders are used for preparation of a first perovskite oxide powder (CaZrO₃ powder).

Moreover, separately, as a glass powder, a crystallized glass powder containing SrO, TiO₂, or the like, which is a raw material of the second perovskite oxide, is prepared. The crystallized glass powder is a glass powder from which crystals are deposited by firing. The crystallized glass powder may additionally contain a simple oxide, such as MnO, SiO₂, Li₂O, B₂O₃, Na₂O, Al₂O₃, P₂O₅, ZnO, Y₂O₃, Ag₂O, BaO, CaO, and/or ZrO₂. The crystallized glass powder may also contain a complex oxide containing at least two elements selected from the group consisting of Mn, Si, Li, B, Na, Al, P, Zn, Y, Ag, Ba, Ca, and/or Zr or may also contain a simple substance of Ag.

Moreover, various powders other than the crystallized glass powder may be prepared. The various powders may be of any type. Examples of the powders include a MnO powder, an alumina filler, and a silica powder (SiO₂ powder).

As raw material powders of the dielectric layers 2 of the present embodiment, powders of high dielectric materials, such as titanium oxide, calcium titanate, perovskite-based oxides (e.g., CaTiO₃—SrTiO₃), and BaNdTiO-based oxides, may further be used.

Separately, an organic vehicle is prepared. The organic vehicle may be of any type. Any organic vehicle normally used in this technical field is prepared.

Then, the first perovskite oxide powder (CaZrO₃ powder) is prepared. Specifically, the Ca oxide raw material powder and the Zr oxide raw material powder are mixed to provide a mixture. Any mixing method may be used. The method may be wet mixing or dry mixing. Note that these raw material powders may contain impurities to the extent that characteristics of a dielectric eventually obtained are not greatly affected. Specifically, the raw material powders may contain less than 0.1 mass % impurities.

Then, the resultant mixture is calcined to provide the CaZrO₃ powder. Calcination conditions are not limited.

The resultant CaZrO₃ powder is appropriately pulverized if necessary for further miniaturization. The CaZrO₃ powder may have any average particle size. The average particle size may be 0.01 μm or more and 30 μm or less.

To the CaZrO₃ powder, preprocessing is performed. The CaZrO₃ powder particles may be, for example, irradiated with a pulsed laser. Through irradiation of the pulsed laser, the vicinity of surfaces of the CaZrO₃ powder particles can be instantly melted and then instantly solidified. This increases amorphousness (reduces crystallinity) of the vicinity of the surfaces of the CaZrO₃ powder particles. That is, only the vicinity of the surfaces of the CaZrO₃ powder particles is brought in an activated state.

Conditions of irradiating the CaZrO₃ powder particles with the pulsed laser are not limited.

Methods of preprocessing are not limited. Any method in which only the vicinity of the surfaces of the CaZrO₃ powder particles is given energy is used. Provided that only the vicinity of the surfaces of the CaZrO₃ powder particles experiences a phase change or that the surfaces of the CaZrO₃ powder particles experience a state change, the method may be something other than irradiating the surfaces of the CaZrO₃ powder particles with the pulsed laser.

Adding the above various powders (e.g., the glass powder) to the preprocessed first perovskite oxide powder, mixing them, and drying them if necessary can provide a dielectric raw material.

The resultant dielectric raw material is blended and mixed with the prepared organic vehicle to provide a dielectric layer paste, which is for forming the dielectric layers 2.

The organic vehicle is a mixture of an organic solvent and a binder dissolved therein. The binder included in the organic vehicle may be of any type. Any of various binders normally used in this technical field is appropriately selected. The organic solvent may be of any type. The organic solvent is appropriately selected from various organic solvents according to the method of manufacturing the multilayer ceramic capacitor (e.g., printing method or sheet method).

Instead of the organic vehicle, an aqueous vehicle may be used for preparation of the dielectric layer paste. The aqueous vehicle is a mixture of water and a water-soluble binder, dispersant, or the like dissolved therein. The water-soluble binder included in the aqueous vehicle may be of any type.

Then, separately from the dielectric layer paste, an internal electrode layer paste is prepared. The internal electrode layer paste is prepared by kneading the above conductive material or various oxides, organic metal compounds, resinate, or the like that become the above conductive material after firing and the above organic vehicle.

An external electrode paste is prepared similarly to the above internal electrode layer paste.

Each of the above pastes may have any organic vehicle content. The organic vehicle content may be a normal content (e.g., binder: about 1 mass % to about 5 mass %, solvent: about 10 mass % to about 50 mass %). Each of the pastes may contain, other than the raw material powders and the organic vehicle, additives selected from various dispersants, plasticizers, or the like as necessary. The internal electrode layer paste and/or the external electrode paste may further contain an inhibitor selected from dielectric materials, insulating materials, or the like. The total content of the additives and the inhibitor may be 10 mass % or less.

In a situation where the printing method is used, the dielectric layer paste and the internal electrode layer paste are printed and laminated on substrates (e.g., PET); the laminate is cut into a predetermined shape; and the cut pieces are peeled off from the substrates to provide green chips.

In a situation where the sheet method is used, green sheets are formed with the dielectric layer paste; the internal electrode layer paste is printed on the green sheets; and they are laminated to provide green chips.

Before firing, the green chips may undergo a binder removal treatment. Conditions of the binder removal treatment are not limited. The heating rate may be 5° C./hour to 6000° C./hour. The holding temperature may be 400° C. to 700° C. The holding time may be 0.5 hours to 24 hours. The binder removal treatment atmosphere is air or a reducing atmosphere.

In a situation where, in particular, the conductive material of the internal electrode layers contains a material that is easily oxidized (e.g., Cu), the atmosphere may be a reducing atmosphere (e.g., a N₂—H₂ gas atmosphere with a H₂ concentration of 10 ppm to 3.0% and a dew point of 20° C. to 90° C.). If the binder removal treatment is performed in air when, in particular, the conductive material of the internal electrode layers contains a material that is easily oxidized (e.g., Cu), delamination easily occurs between the internal electrode layers and the dielectric layers during firing. Delamination easily increases dielectric loss tan δ.

Firing conditions of the green chips are not limited. The holding temperature may be 850° C. to 1000° C. The holding time may be 30 minutes to 600 minutes. Note that the upper limit of the holding temperature is lower than the melting point of the conductive material of the internal electrode layers. The firing atmosphere may be a reducing atmosphere.

Conventionally, in a situation where a perovskite oxide powder is mixed with a raw material of another component and this mixture is fired, the vicinity of surfaces of the perovskite oxide powder particles may have been provided with a region with a high content of the another component.

The perovskite oxide powder that has underwent the above preprocessing has high amorphousness in the vicinity of the surfaces. In a situation where such a perovskite oxide powder is mixed with the raw materials of other components and this mixture is fired, the vicinity of the surfaces of the perovskite oxide powder particles is provided with a region with a high content of the other components so that the vicinity of the surfaces of the perovskite oxide powder has a crystal orientation different from that of the inside of the perovskite oxide powder.

Further, to provide the dielectric composition according to the present embodiment, the green chips are held at a holding temperature of 800° C. for a short amount of time during cooling. The holding time at 800° C. is not limited and may be 2.0 to 30 minutes. The cooling rate from the holding temperature of firing to 800° C. may be 2.0° C./min to 100° C./min. The cooling rate from 800° C. to room temperature may be 2.0° C./min to 10° C./min. The cooling atmosphere may be a reducing atmosphere.

Through the above pulsed laser irradiation, the amorphousness of the vicinity of the surfaces of the CaZrO₃ powder particles has increased, which has brought the vicinity of the surfaces in the activated state. Performing firing in this state makes mainly the Sr oxide and the Ti oxide solid-dissolve in surfaces of the dielectric grains containing the first perovskite oxide. Moreover, in a situation where the Sr oxide and the Ti oxide solid-dissolve at a suitable content, MnO also solid-dissolves in the surfaces of the dielectric grains. Intentionally providing the holding time at 800° C. during cooling while these oxides are solid-dissolved enables the Sr oxide and the Ti oxide to become SrTiO₃ and crystallize. Consequently, the dielectric grains having the structure in which the core portion contains CaZrO₃ and the shell portion contains SrTiO₃ in addition to CaZrO₃ are provided. Moreover, the shell portion easily contains MnO.

In a situation where, in particular, the conductive material of the internal electrode layers contains a material that is easily oxidized (e.g., Cu), the atmosphere may be a reducing atmosphere (e.g., a N₂—H₂ gas atmosphere with a H₂ concentration of 10 ppm to 3.0% and a dew point of 10° C. to 50° C.). If firing is performed in air when, in particular, the conductive material of the internal electrode layers contains a material that is easily oxidized (e.g., Cu), delamination easily occurs between the internal electrode layers and the dielectric layers. Delamination easily increases dielectric loss tan δ. The oxygen partial pressure of the atmosphere is not limited and may be 7.2× 10⁻¹⁵ atm to 4.7×10⁻¹³ atm.

Conditions of annealing, if to be performed, are not limited. The holding temperature may be, for example, 800° C. to 1000° C. The holding time may be, for example, 0.5 to 3.0 hours. The atmosphere may be a reducing atmosphere. The atmosphere may be, for example, a humidified N₂ gas (oxygen partial pressure: 4.3× 10⁻⁹ to 6.2×10⁻⁷ MPa).

Then, the external electrode paste is baked with a known method. This can form the external electrodes electrically connected to the internal electrode layers.

Hereinabove, one suitable embodiment of the multilayer electronic device according to the present disclosure has been described; however, the present disclosure is not construed as limited to the above embodiment.

### Examples

Hereinafter, the present disclosure is described in more detail with reference to examples and comparative examples; however, the present disclosure is not construed as limited to the following examples.

### Experiment 1

First, a raw material powder of an oxide of an element contained in the A-site of a first perovskite oxide and a raw material powder of an oxide of an element contained in the B-site of the first perovskite oxide were prepared and were weighed.

“The raw material powder of the oxide of the element contained in the A-site” means a powder of the oxide of the element contained in the A-site and/or a powder of a compound that becomes the oxide of the element contained in the A-site through a heat treatment. “The raw material powder of the oxide of the element contained in the B-site” means a powder of the oxide of the element contained in the B-site and/or a powder of a compound that becomes the oxide of the element contained in the B-site through a heat treatment.

Separately, as a glass powder, prepared was a crystallized glass powder containing 10.0 to 25.0 mass % oxide of an element contained in the A-site of a second perovskite oxide, 10.0 to 25.0 mass % oxide of an element contained in the B-site of the second perovskite oxide, 20.0 to 30.0 mass % SiO₂, 15.0 to 25.0 mass % MnO, and 0 mass % or more and less than 10.0 mass % Li, B, Na, Al, P, Zn, Y, Ag, Ba, Ca, and Zr in total. Separately from the crystallized glass powder, a SiO₂ powder and a MnO powder were prepared as necessary.

The mix ratio of the raw material powders and the composition of the glass powder were controlled so that, with a main component raw material powder eventually obtained, a core portion contained the first perovskite oxide, a shell portion contained both the first perovskite oxide and the second perovskite oxide, and a of the shell portion was as shown in each table. Note that Sample Nos. 1, 8, 15, 22, 29, and 36 were carried out as in Examples whose first perovskite oxide was the same as that of the former samples, except that the second perovskite oxide was replaced with that first perovskite oxide.

Then, the raw material powder of the oxide of the element contained in the A-site of the first perovskite oxide and the raw material powder of the oxide of the element contained in the B-site of the first perovskite oxide were wet-mixed in a ball mill with ion-exchanged water as a dispersion medium. The resultant mixture was dried to provide a mixed raw material powder.

Then, the resultant mixed raw material powder was calcined to provide a first perovskite oxide powder. Calcination conditions were as follows. The heat treatment atmosphere was an air atmosphere. The holding temperature was 800° C. The holding time was 2.0 hours.

The first perovskite oxide powder was wet-pulverized in a ball mill with ion-exchanged water as a dispersion medium.

The wet-pulverized first perovskite oxide powder was irradiated with a pulsed laser.

Further, to the first perovskite oxide powder after the pulsed laser irradiation, the crystallized glass powder and, if necessary, further the SiO₂ powder and/or the MnO powder were added. The powders were mixed. The mixture was further dried to provide a dielectric raw material.

To 100 parts by mass dielectric raw material, 10 parts by mass water solution including 6 parts by mass polyvinyl alcohol resin as a binder was added. They were granulated to provide a granulated powder.

The resultant granulated powder was introduced into a φ 12 mm mold, was temporarily press-molded with a pressure of 0.6 ton/cm², and was further press-molded with a pressure of 1.2 ton/cm² to provide a disc-shaped green compact.

Then, the resultant green compact underwent a binder removal treatment, firing, and annealing under the following conditions to provide an element body.

Conditions of the binder removal treatment were a holding temperature of 400° C., a temperature holding time of 2 hours, and a reducing atmosphere.

Conditions of firing were a holding temperature of 1000° C., a temperature holding time of 2 hours, and a humidified N₂+H₂ mixed gas atmosphere. The oxygen partial pressure at 1000° C. was 10⁻⁵ MPa. To humidify the ambient gas for firing, a wetter was used.

Further, after the temperature holding at 1000° C., the temperature was cooled to room temperature. The cooling rate was 10° C./min until the temperature reached 800° C. The temperature holding time at 800° C. was 10 minutes. The cooling rate from 800° C. to room temperature was 3.0° C./min.

Conditions of annealing were a holding temperature of 1050° C., a temperature holding time of 2 hours, and a humidified N₂ gas atmosphere (oxygen partial pressure of 10⁻⁷ MPa). To humidify the ambient gas for annealing, a wetter was used.

Relative permittivity, dielectric loss (tan δ), relative density, resistivity, and average a of the resultant sintered body (dielectric composition) were found using the following methods. For measurement of relative permittivity, dielectric loss, and resistivity, an In—Ga electrode was applied to the above dielectric composition (sintered body) to provide a disc-shaped ceramic capacitor sample (capacitor sample).

### <Relative Permittivity ε and Dielectric Loss (tan δ)>

A signal with a frequency of 2 GHz and an input signal level (measurement voltage) of 1 Vrms was applied to the capacitor sample using an impedance analyzer (E4991B manufactured by Keysight Technologies, Inc.) at room temperature to measure ¿ and tan δ. An ε of 25 or more was deemed good. An ε of 30 or more was deemed better. In all Examples, it was confirmed that & was 25 or more. A tan δ of 0.0100 or less (1.00% or less) was deemed good. A tan δ of 0.0015 or less (0.15% or less) was deemed better. A tan δ of 0.00070 or less (0.070% or less) was deemed best.

### <Relative Density>

First, the density of the sintered body was calculated from its dimensions and mass. Then, the calculated density of the sintered body was divided by the theoretical density found from the literature values of the densities of the perovskite compounds to calculate the relative density. Note that the theoretical density was found using the crystal structures of the perovskite oxides checked with XRD and the types of the perovskite oxides. A relative density of 80% or more was deemed good. A relative density of 85% or more was deemed better. A relative density of 90% or more was deemed best.

### <Resistivity (IR)>

Insulation resistance of the capacitor sample was measured using a digital resistance meter (R8340 manufactured by Advantest Corporation) at a reference temperature (25° C.). The measurement voltage was 200 V. The measurement time was 60 seconds. From the insulation resistance, the effective electrode area, and the thickness of the dielectric composition, the resistivity IR was calculated. An IR of 1.0×10¹⁰ Ωm or more was deemed good. An IR of 1.0×10¹¹ Ωm or more was deemed better. An IR of 1.0×10¹² Ωm or more was deemed still better. An IR of 5.0×10¹² Ωm or more was deemed best. Note that, in the tables, “rE+s” means “r×10^{+s}”.

### <Heat Characteristics>

Capacitance was measured using a digital LCR meter (4284A manufactured by YHP) at 25° C. and 125° C. At that time, the measurement frequency was 1 MHz, and the measurement voltage was 1 Vrms. The rate of change Tc of the capacitance at 125° C. against the capacitance at 25° C. was calculated. A Tc of 30 ppm/° C. or less was deemed good. A Tc of 15 ppm/° C. or less was deemed better. A Tc of 10 ppm/° C. or less was deemed best.

### <Average α>

A section of the sintered body was observed using STEM-EDS at a magnification of ×100000 to identify dielectric grains 12 and a grain boundary 14. Thirty measurement lines that passed through the grain boundary and respective dielectric grains, were perpendicular to the outer peripheries of the dielectric grains, and had a length of 150 nm or more were drawn. For each measurement line, a line analysis was performed at measurement intervals of 5.0 nm. Calculated values of a were averaged. It was confirmed that the average a was as shown in each table.

### <Presence or Absence of Mn in Shell Portion>

In the above line analysis, the Mn content of the shell portion 12b was confirmed. When the shell portion 12b included a measurement point with a Mn content of 0.5 mol % or more, Mn was deemed present.

### <Average Circle Equivalent Diameter>

Circle equivalent diameters of at least five hundred dielectric grains 12 in a SEM sectional image were measured and were averaged. In all Examples, it was confirmed that the average circle equivalent diameter was 0.05 μm or more and 5.0 μm or less.

### <Microstructure>

In all Examples, it was confirmed, using electron diffraction patterns, that the first perovskite oxide was present as an oxide having a perovskite structure in the sintered body and that the second perovskite oxide was present as an oxide having a perovskite structure in the sintered body.

TABLE 1

| Sample | Example/ | First perovskite oxide | | Second perovskite oxide | | | Relative density | tanδ | IR |
|---|---|---|---|---|---|---|---|---|---|
| No. | Comparative Example | A-site element | B-site element | A-site element | B-site element | α | [%] | [-] | [Ωm] |
| 1 | Comparative Example | Ba | Ti | Ba | Ti | — | 62 | 0.52 | 2.1E+06 |
| 2 | Example | Ba | Ti | Sr | Ti | 0.050 | 91 | 0.0081 | 3.0E+10 |
| 3 | Example | Ba | Ti | Ca | Ti | 0.050 | 87 | 0.0093 | 4.3E+10 |
| 4 | Example | Ba | Ti | Ba | Zr | 0.050 | 89 | 0.0090 | 2.8E+10 |
| 5 | Example | Ba | Ti | Ca | Zr | 0.050 | 86 | 0.0078 | 4.5E+10 |
| 6 | Example | Ba | Ti | Sr | Zr | 0.050 | 87 | 0.0094 | 1.9E+10 |
| 7 | Example | Sr | Ti | Ba | Ti | 0.050 | 88 | 0.0073 | 3.2E+10 |
| 8 | Comparative Example | Sr | Ti | Sr | Ti | — | 69 | 0.26 | 3.0E+06 |
| 9 | Example | Sr | Ti | Ca | Ti | 0.050 | 86 | 0.0071 | 4.0E+10 |
| 10 | Example | Sr | Ti | Ba | Zr | 0.050 | 90 | 0.0063 | 5.2E+10 |
| 11 | Example | Sr | Ti | Ca | Zr | 0.050 | 92 | 0.0052 | 4.8E+10 |
| 12 | Example | Sr | Ti | Sr | Zr | 0.050 | 90 | 0.0064 | 3.4E+10 |
| 13 | Example | Ca | Ti | Ba | Ti | 0.050 | 88 | 0.0055 | 3.7E+10 |
| 14 | Example | Ca | Ti | Sr | Ti | 0.050 | 91 | 0.0061 | 3.7E+10 |
| 15 | Comparative Example | Ca | Ti | Ca | Ti | — | 67 | 0.38 | 2.4E+06 |
| 16 | Example | Ca | Ti | Ba | Zr | 0.050 | 86 | 0.0079 | 2.8E+10 |
| 17 | Example | Ca | Ti | Ca | Zr | 0.050 | 91 | 0.0048 | 4.9E+10 |
| 18 | Example | Ca | Ti | Sr | Zr | 0.050 | 87 | 0.0072 | 3.0E+10 |

TABLE 2

| | Example/ | | | | | | Relative | | |
|---|---|---|---|---|---|---|---|---|---|
| Sample | Comparative | First perovskite oxide | | Second perovskite oxide | | | density | tanδ | IR |
| No. | Example | A-site element | B-site element | A-site element | B-site element | α | [%] | [-] | [Ωm] |
| 19 | Example | Ba | Zr | Ba | Ti | 0.050 | 89 | 0.0051 | 7.9E+11 |
| 20 | Example | Ba | Zr | Sr | Ti | 0.050 | 90 | 0.0043 | 8.8E+11 |
| 21 | Example | Ba | Zr | Ca | Ti | 0.050 | 88 | 0.0042 | 1.4E+12 |
| 22 | Comparative | Ba | Zr | Ba | Zr | — | 63 | 0.33 | 7.0E+06 |
| | Example | | | | | | | | |
| 23 | Example | Ba | Zr | Ca | Zr | 0.050 | 90 | 0.0048 | 1.1E+12 |
| 24 | Example | Ba | Zr | Sr | Zr | 0.050 | 87 | 0.0056 | 9.1E+11 |
| 25 | Example | Ca | Zr | Ba | Ti | 0.050 | 94 | 0.0012 | 2.4E+12 |
| 26 | Example | Ca | Zr | Sr | Ti | 0.050 | 97 | 0.00065 | 5.3E+12 |
| 27 | Example | Ca | Zr | Ca | Ti | 0.050 | 96 | 0.0021 | 2.0E+12 |
| 28 | Example | Ca | Zr | Ba | Zr | 0.050 | 92 | 0.0039 | 9.0E+11 |
| 29 | Comparative | Ca | Zr | Ca | Zr | — | 62 | 0.25 | 4.2E+07 |
| | Example | | | | | | | | |
| 30 | Example | Ca | Zr | Sr | Zr | 0.050 | 93 | 0.0027 | 1.6E+12 |
| 31 | Example | Sr | Zr | Ba | Ti | 0.050 | 86 | 0.0067 | 7.8E+11 |
| 32 | Example | Sr | Zr | Sr | Ti | 0.050 | 92 | 0.0044 | 1.6E+12 |
| 33 | Example | Sr | Zr | Ca | Ti | 0.050 | 86 | 0.0054 | 8.6E+11 |
| 34 | Example | Sr | Zr | Ba | Zr | 0.050 | 89 | 0.0059 | 9.4E+11 |
| 35 | Example | Sr | Zr | Ca | Zr | 0.050 | 90 | 0.0046 | 1.2E+12 |
| 36 | Comparative | Sr | Zr | Sr | Zr | — | 64 | 0.41 | 8.0E+06 |
| | Example | | | | | | | | |

TABLE 3

| | | First perovskite oxide | | Second perovskite oxide | | | Relative | | |
|---|---|---|---|---|---|---|---|---|---|
| Sample | Example/ | | B-site | | B-site | | density | tanδ | IR |
| No. | Comparative Example | A-site element | element | A-site element | element | α | [%] | [-] | [Ωm] |
| 1 | Comparative Example | Ba | Ti | Ba | Ti | — | 62 | 0.52 | 2.1E+06 |
| 37 | Example | Ba_{0.5}Ca_{0.5} | Ti | Ba | Ti | 0.050 | 83 | 0.0088 | 2.3E+10 |
| 13 | Example | Ca | Ti | Ba | Ti | 0.050 | 88 | 0.0055 | 3.7E+10 |
| 8 | Comparative Example | Sr | Ti | Sr | Ti | — | 69 | 0.26 | 3.0E+06 |
| 38 | Example | Ba_{0.6}Sr_{0.4} | Ti | Sr | Ti | 0.050 | 89 | 0.0082 | 6.6E+10 |
| 2 | Example | Ba | Ti | Sr | Ti | 0.050 | 91 | 0.0081 | 3.0E+10 |
| 15 | Comparative Example | Ca | Ti | Ca | Ti | — | 67 | 0.38 | 2.4E+06 |
| 39 | Example | Ca_{0.7}Sr_{0.3} | Ti | Ca | Ti | 0.050 | 88 | 0.0071 | 4.2E+10 |
| 9 | Example | Sr | Ti | Ca | Ti | 0.050 | 86 | 0.0071 | 4.0E+10 |
| 22 | Comparative Example | Ba | Zr | Ba | Zr | — | 63 | 0.33 | 7.0E+06 |
| 40 | Example | Ba | Ti_{0.7}Zr_{0.3} | Ba | Zr | 0.050 | 82 | 0.0079 | 5.1E+10 |
| 4 | Example | Ba | Ti | Ba | Zr | 0.050 | 89 | 0.0090 | 2.8E+10 |
| 36 | Comparative Example | Sr | Zr | Sr | Zr | — | 64 | 0.41 | 8.0E+06 |
| 41 | Example | Sr | Ti_{0.5}Zr_{0.5} | Sr | Zr | 0.050 | 81 | 0.0053 | 8.0E+10 |
| 12 | Example | Sr | Ti | Sr | Zr | 0.050 | 90 | 0.0064 | 3.4E+10 |
| 29 | Comparative Example | Ca | Zr | Ca | Zr | — | 62 | 0.25 | 4.2E+07 |
| 42 | Example | Ca | Ti_{0.3}Zr_{0.7} | Ca | Zr | 0.050 | 86 | 0.0062 | 7.8E+10 |
| 17 | Example | Ca | Ti | Ca | Zr | 0.050 | 91 | 0.0048 | 4.9E+10 |
| 1 | Comparative Example | Ba | Ti | Ba | Ti | — | 62 | 0.52 | 2.1E+06 |
| 43 | Example | Ba_{0.5}Sr_{0.5} | Ti_{0.6}Zr_{0.4} | Ba | Ti | 0.050 | 86 | 0.0077 | 3.5E+10 |
| 31 | Example | Sr | Zr | Ba | Ti | 0.050 | 86 | 0.0067 | 7.8E+11 |
| 8 | Comparative Example | Sr | Ti | Sr | Ti | — | 69 | 0.26 | 3.0E+06 |
| 44 | Example | Ca_{0.7}Sr_{0.3} | Ti_{0.3}Zr_{0.7} | Sr | Ti | 0.050 | 82 | 0.0046 | 1.1E+11 |
| 26 | Example | Ca | Zr | Sr | Ti | 0.050 | 97 | 0.00065 | 5.3E+12 |
| 15 | Comparative Example | Ca | Ti | Ca | Ti | — | 67 | 0.38 | 2.4E+06 |
| 45 | Example | Ba_{0.5}Ca_{0.2}Sr_{0.3} | Ti_{0.3}Zr_{0.7} | Ca | Ti | 0.050 | 84 | 0.0081 | 4.1E+10 |
| 21 | Example | Ba | Zr | Ca | Ti | 0.050 | 88 | 0.0042 | 1.4E+12 |
| 27 | Example | Ca | Zr | Ca | Ti | 0.050 | 96 | 0.0021 | 2.0E+12 |
| 33 | Example | Sr | Zr | Ca | Ti | 0.050 | 86 | 0.0054 | 8.6E+11 |

Table 1 shows Examples and Comparative Examples with Ti as the element contained in the B-site of the first perovskite oxide and varying other elements. Each Example, in which the dielectric grains had a specific core-shell structure, had high relative density of the dielectric composition eventually obtained and good characteristics. In contrast, Sample Nos. 1, 8, and 15, in which the dielectric grains did not have the specific core-shell structure, had low sinterability, significantly low relative density of the dielectric composition eventually obtained, and significantly poor tan δ and IR.

Table 2 shows Examples and Comparative Examples with Zr as the element contained in the B-site of the first perovskite oxide and varying other elements. Each Example, in which the dielectric grains had the specific core-shell structure, had high relative density of the dielectric composition eventually obtained and good characteristics. In contrast, Sample Nos. 22, 29, and 36, in which the dielectric grains did not have the specific core-shell structure, had low sinterability, significantly low relative density of the dielectric composition eventually obtained, and significantly poor tan δ and IR.

Sample Nos. 37 to 45 of Table 3 were Examples that contained two or more elements at the A-site of the first perovskite oxide and/or two or more elements at the B-site of the first perovskite oxide. Each Example, in which the dielectric grains had the specific core-shell structure, had high relative density of the dielectric composition eventually obtained and good characteristics.

TABLE 4

| | | | | | | Relative | | | Tc |
|---|---|---|---|---|---|---|---|---|---|
| Sample | First perovskite oxide | | Second perovskite oxide | | | density | tanδ | IR | [ppm/ |
| No. | A-site element | B-site element | A-site element | B-site element | α | [%] | [-] | [Ωm] | ° C.] |
| 46 | Ca | Zr | Ba | Ti | 0.005 | 93 | 0.0037 | 1.2E+12 | 21 |
| 47 | Ca | Zr | Ba | Ti | 0.010 | 93 | 0.0024 | 1.8E+12 | 18 |
| 48 | Ca | Zr | Ba | Ti | 0.020 | 95 | 0.0019 | 2.3E+12 | 16 |
| 25 | Ca | Zr | Ba | Ti | 0.050 | 94 | 0.0012 | 2.4E+12 | 16 |
| 49 | Ca | Zr | Ba | Ti | 0.075 | 96 | 0.0024 | 2.7E+12 | 17 |
| 50 | Ca | Zr | Ba | Ti | 0.10 | 93 | 0.0028 | 1.9E+12 | 19 |
| 51 | Ca | Zr | Ba | Ti | 0.13 | 91 | 0.0041 | 2.0E+12 | 22 |
| 52 | Ca | Zr | Sr | Ti | 0.005 | 94 | 0.0013 | 3.1E+12 | 14 |
| 53 | Ca | Zr | Sr | Ti | 0.010 | 92 | 0.00090 | 3.6E+12 | 12 |
| 54 | Ca | Zr | Sr | Ti | 0.020 | 97 | 0.00074 | 5.6E+12 | 10 |
| 26 | Ca | Zr | Sr | Ti | 0.050 | 97 | 0.00065 | 5.3E+12 | 10 |
| 55 | Ca | Zr | Sr | Ti | 0.075 | 92 | 0.00072 | 3.5E+12 | 11 |
| 56 | Ca | Zr | Sr | Ti | 0.10 | 92 | 0.00087 | 2.9E+12 | 12 |
| 57 | Ca | Zr | Sr | Ti | 0.13 | 93 | 0.0012 | 3.0E+12 | 15 |
| 58 | Ca | Zr | Ca | Ti | 0.005 | 94 | 0.0048 | 1.9E+12 | 27 |
| 59 | Ca | Zr | Ca | Ti | 0.010 | 91 | 0.0038 | 2.1E+12 | 23 |
| 60 | Ca | Zr | Ca | Ti | 0.020 | 96 | 0.0030 | 2.4E+12 | 21 |
| 27 | Ca | Zr | Ca | Ti | 0.050 | 96 | 0.0021 | 2.0E+12 | 18 |
| 61 | Ca | Zr | Ca | Ti | 0.075 | 92 | 0.0021 | 2.1E+12 | 18 |
| 62 | Ca | Zr | Ca | Ti | 0.10 | 91 | 0.0029 | 1.6E+12 | 20 |
| 63 | Ca | Zr | Ca | Ti | 0.13 | 94 | 0.0049 | 1.1E+12 | 26 |

Table 4 shows Examples carried out as in Sample Nos. 25, 26, and 27 except that a was changed. Each Example satisfying 0.010≤α≤0.10 in particular had better characteristics than those of Examples carried out under the same conditions except that α was 0.005 or 0.130.

TABLE 5

| | First perovskite oxide | | Second perovskite oxide | | | Shell | Relative | | | | |
|---|---|---|---|---|---|---|---|---|---|---|---|
| Sample | A-site | | A-site | | | portion | density | ε | tanδ | IR | Tc |
| No. | element | B-site element | element | B-site element | α | Mn | [%] | [-] | [-] | [Ωm] | [ppm/° C.] |
| 53 | Ca | Zr | Sr | Ti | 0.010 | Absent | 92 | 32 | 0.00090 | 3.6E+12 | 12 |
| 64 | Ca | Zr | Sr | Ti | 0.015 | Absent | 93 | 33 | 0.00081 | 4.1E+12 | 11 |
| 54 | Ca | Zr | Sr | Ti | 0.020 | Present | 97 | 32 | 0.00074 | 5.6E+12 | 10 |
| 65 | Ca | Zr | Sr | Ti | 0.025 | Present | 99 | 34 | 0.00052 | 5.8E+12 | 10 |
| 66 | Ca | Zr | Sr | Ti | 0.030 | Present | 98 | 34 | 0.00044 | 5.8E+12 | 9 |
| 67 | Ca | Zr | Sr | Ti | 0.035 | Present | 96 | 33 | 0.00046 | 5.5E+12 | 11 |
| 68 | Ca | Zr | Sr | Ti | 0.040 | Present | 97 | 32 | 0.00051 | 5.4E+12 | 10 |
| 69 | Ca | Zr | Sr | Ti | 0.045 | Present | 95 | 31 | 0.00058 | 5.1E+12 | 10 |
| 26 | Ca | Zr | Sr | Ti | 0.050 | Present | 97 | 31 | 0.00065 | 5.3E+12 | 10 |
| 70 | Ca | Zr | Sr | Ti | 0.055 | Present | 95 | 30 | 0.00062 | 5.2E+12 | 10 |
| 71 | Ca | Zr | Sr | Ti | 0.060 | Absent | 93 | 33 | 0.00063 | 4.0E+12 | 11 |
| 72 | Ca | Zr | Sr | Ti | 0.065 | Absent | 92 | 32 | 0.00063 | 3.9E+12 | 11 |
| 73 | Ca | Zr | Sr | Ti | 0.070 | Absent | 93 | 32 | 0.00067 | 3.2E+12 | 12 |
| 55 | Ca | Zr | Sr | Ti | 0.075 | Absent | 92 | 31 | 0.00072 | 3.5E+12 | 11 |

Table 5 shows Examples carried out as in Sample Nos. 26 and 53 to 55 except that a was changed. In particular, Examples satisfying 0.025≤α≤0.070 had good tan δ. In particular, Examples satisfying 0.020≤α≤0.055 had Mn contained in the shell portion and had particularly good IR.

### Experiment 2

Experiment 2 was conducted as in each Example of Tables 1 to 3 of Experiment 1 except that the wet-pulverized first perovskite oxide powder was not irradiated with a pulsed laser. In a situation where no pulsed laser irradiation was performed, neither the core portion nor the shell portion of the dielectric grains containing the first perovskite oxide powder contained the second perovskite oxide. Consequently, relative density, tan δ, and IR were as poor as those of Comparative Examples of Tables 1 to 3.

### REFERENCE NUMERALS

1 . . . multilayer ceramic capacitor
2 . . . dielectric layer
3 . . . internal electrode layer
4 . . . external electrode
10 . . . capacitor element body
12 . . . dielectric grain
12a . . . core portion
12b . . . shell portion
14 . . . grain boundary

What is claimed is:

1. A dielectric composition comprising a dielectric grain, wherein
the dielectric grain comprises a core portion and a shell portion;
the core portion comprises a first perovskite oxide as a main component;
the shell portion comprises the first perovskite oxide and a second perovskite oxide as a main component, the second perovskite oxide having a composition different from that of the first perovskite oxide;
the first perovskite oxide comprises at least one selected from the group consisting of Ba, Sr, and Ca at the A-site and at least one selected from the group consisting of Ti and Zr at the B-site; and
the second perovskite oxide comprises at least one selected from the group consisting of Ba, Sr, and Ca at the A-site and at least one selected from the group consisting of Ti and Zr at the B-site.

2. The dielectric composition according to claim 1, wherein
the first perovskite oxide comprises Ca most at the A-site and Zr most at the B-site based on number of atoms, and
the second perovskite oxide comprises Sr most at the A-site and Ti most at the B-site based on number of atoms.

3. The dielectric composition according to claim 1, wherein
the first perovskite oxide comprises 50.0 at % or more Ca at the A-site and 50.0 at % or more Zr at the B-site, and
the second perovskite oxide comprises 50.0 at % or more Sr at the A-site and 50.0 at % or more Ti at the B-site.

4. The dielectric composition according to claim 1, wherein
the first perovskite oxide comprises 60.0 at % or more Ca at the A-site and 60.0 at % or more Zr at the B-site, and
the second perovskite oxide comprises 60.0 at % or more Sr at the A-site and 60.0 at % or more Ti at the B-site.

5. The dielectric composition according to claim 1, wherein
the first perovskite oxide comprises 70.0 at % or more Ca at the A-site and 70.0 at % or more Zr at the B-site, and
the second perovskite oxide comprises 70.0 at % or more Sr at the A-site and 70.0 at % or more Ti at the B-site.

6. The dielectric composition according to claim 1, wherein
the first perovskite oxide comprises CaZrO₃, and
the second perovskite oxide comprises SrTiO₃.

7. The dielectric composition according to claim 2, wherein a content ratio of the second perovskite oxide to a total of the first perovskite oxide and the second perovskite oxide in the shell portion is 0.010 or more and 0.10 or less based on number of atoms.

8. The dielectric composition according to claim 2, wherein a content ratio of the second perovskite oxide to a total of the first perovskite oxide and the second perovskite oxide in the shell portion is 0.025 or more and 0.070 or less based on number of atoms.

9. The dielectric composition according to claim 2, wherein, based on number of atoms, the core portion has a smaller content ratio of the second perovskite oxide to a total of the first perovskite oxide and the second perovskite oxide than the shell portion.

10. The dielectric composition according to claim 9, wherein the content ratio of the second perovskite oxide to the total of the first perovskite oxide and the second perovskite oxide in the core portion is 0.

11. The dielectric composition according to claim 1, wherein
the dielectric grain comprises dielectric grains,
the dielectric composition comprises a grain boundary between the dielectric grains, and
the grain boundary comprises an oxide of at least one selected from the group consisting of Si, Mn, Sr, and Ti.

12. The dielectric composition according to claim 1, wherein
the dielectric grain comprises dielectric grains,
the dielectric composition comprises a grain boundary between the dielectric grains, and
the grain boundary comprises all of a Si oxide, a Mn oxide, a Sr oxide, and a Ti oxide.

13. The dielectric composition according to claim 11, wherein the shell portion comprises Mn.

14. The dielectric composition according to claim 13, wherein the shell portion has an average Mn content of 0.5 mol % or more.

15. A dielectric element comprising the dielectric composition according to claim 1.

16. An electronic device comprising the dielectric composition according to claim 1.

17. A multilayer electronic device comprising:
dielectric layers comprising the dielectric composition according to claim 1; and
internal electrode layers,
wherein the dielectric layers and the internal electrode layers are alternately laminated.

18. The multilayer electronic device according to claim 17, wherein the internal electrode layers comprise Cu.
